(19) United States
(12) Patent Application Publication
(10) Pub. No.: US 2025/0149827 A1
(43) Pub. Date: May 8, 2025

(54) CONTACT ORGANIZER FOR A PLUG CONNECTOR

(71) Applicant: TE Connectivity Solutions GmbH, Schaffhausen (CH)

(72) Inventors: Vinayakumar Shettar, Middletown, PA (US); Richard C. Batley, Middletown, PA (US); Thomas Klenner, Middletown, PA (US); Alexander Brong, Middletown, PA (US)

(21) Appl. No.: 18/409,339

(22) Filed: Jan. 10, 2024

Related U.S. Application Data
(60) Provisional application No. 63/596,498, filed on Nov. 6, 2023.

(51) Int. Cl. H01R 13/629; H01R 13/05; H01R 13/11; H01R 13/502

(52) U.S. Cl. CPC H01R 13/629; H01R 13/052; H01R 13/111; H01R 13/502

(57) ABSTRACT

A plug connector includes a plug housing extending between a front and a rear. The front configured to be mated with a header housing. The plug housing includes contact channels extending longitudinally between the front and the rear. The plug connector includes contacts received in the contact channels. The contacts include sockets at mating ends of the contacts configured to receive pin contacts of the header housing. The contacts are arranged in an array has multiple rows and multiple columns. The plug connector includes a contact organizer coupled to the front of the plug housing. The contact organizer has bores therethrough aligned with the corresponding contact channels. The contact organizer has guide features configured to center the pin contacts in the bores to align the pin contacts with the sockets.

### CROSS REFERENCE TO RELATED APPLICATIONS

This application claims benefit to U.S. Provisional Application No. 63/596,498, filed 6 Nov. 2023, titled “CONTACT ORGANIZER FOR A PLUG CONNECTOR”, the subject matter of which is herein incorporated by reference in its entirety.

### BACKGROUND OF THE INVENTION

The subject matter herein relates generally to electrical connector systems.

Electrical connectors are used in electronics systems to provide transmission of electrical signals between various components. The connectors typically include an array of pin and socket contacts that must align precisely to establish a reliable electrical connection. However, conventional connector designs often encounter challenges relating to accurate alignment of the contact, leading to intermittent or unstable electrical connections. Additionally, damage to the contact may occur during mating with the contacts are improperly aligned. Some known connectors rely on precise machining techniques to aide in aligning the contact, which can add complexity and cost to the connector manufacturing process. Additionally, such solutions may not always provide a robust remedy for the alignment issue, particularly in scenarios where connectors need to be mated in challenging environments or under dynamic conditions.

A need remains for a robust and cost-effective solution for aligning the contact of the electrical connectors during mating.

### BRIEF DESCRIPTION OF THE INVENTION

In one embodiment, a plug connector is provided and includes a plug housing extending between a front and a rear. The front configured to be mated with a header housing. The plug housing includes contact channels extending longitudinally between the front and the rear. The plug connector includes contacts received in the contact channels. The contacts include sockets at mating ends of the contacts configured to receive pin contacts of the header housing. The contacts are arranged in an array has multiple rows and multiple columns. The plug connector includes a contact organizer coupled to the front of the plug housing. The contact organizer has bores therethrough aligned with the corresponding contact channels. The contact organizer has guide features configured to center the pin contacts in the bores to align the pin contacts with the sockets.

In another embodiment, a plug connector is provided and includes a plug housing extending between a front and a rear. The front configured to be mated with a header housing. The plug housing includes contact channels extending longitudinally between the front and the rear. The plug connector includes contacts received in the contact channels. The contacts include sockets at mating ends of the contacts configured to receive pin contacts of the header housing. The sockets have distal edges configured to receive the pin contacts. The contacts are arranged in an array has multiple rows and multiple columns. The plug connector includes a contact organizer coupled to the front of the plug housing. The contact organizer has bores therethrough aligned with the corresponding contact channels. The contact organizer has caps extending into the bores. The caps overhanging the distal ends of the sockets. The contact organizer has guide features forward of the caps configured to center the pin contacts in the bores to align the pin contacts with the sockets.

In a further embodiment, an electrical connector system is provided and includes a header connector that has a header housing has channels holding pin contacts in an array has multiple rows and multiple columns. The header housing includes a shroud at a mating end of the header connector forming a cavity. The pin contacts extend into the cavity. The electrical connector system includes a plug connector mated with the header connector. The plug connector includes a plug housing holding contacts in an array having multiple rows and multiple columns. The plug housing extends between a front and a rear. The front is configured to be plugged into the cavity of the header housing. The plug housing includes contact channels that receive the corresponding contacts. The contacts include sockets at mating ends of the contacts configured to receive the corresponding pin contacts. The plug connector includes a contact organizer coupled to the front of the plug housing. The contact organizer has bores therethrough aligned with the corresponding contact channels. The contact organizer has guide features configured to center the pin contacts in the bores to align the pin contacts with the sockets during mating.

### BRIEF DESCRIPTION OF THE DRAWINGS

FIG. 1 is a front perspective view of an electrical connector system in accordance with an exemplary embodiment.

FIG. 2 is a rear perspective view of the electrical connector system in accordance with an exemplary embodiment.

FIG. 3 is an exploded, front perspective view of the electrical connector system in accordance with an exemplary embodiment.

FIG. 4 is an exploded, rear perspective view of the electrical connector system in accordance with an exemplary embodiment.

FIG. 5 is a perspective view of the plug connector in accordance with an exemplary embodiment.

FIG. 6 is an exploded, perspective view of the plug connector in accordance with an exemplary embodiment.

FIG. 7 is a cross-sectional view of a portion of the plug connector in accordance with an exemplary embodiment.

FIG. 8 is a perspective view of the header connector in accordance with an exemplary embodiment.

FIG. 9 is a cross sectional view of a portion of the header connector in accordance with an exemplary embodiment.

FIG. 10 is a cross-sectional view of a portion of the header connector in accordance with an exemplary embodiment.

FIG. 11 is a cross sectional view of the electrical connector system in accordance with an exemplary embodiment showing the plug connector partially mated with the header connector.

FIG. 12 is a cross sectional view of a portion of the electrical connector system in accordance with an exemplary embodiment showing the plug connector partially mated with the header connector.

FIG. 13 is a perspective view of the header connector in accordance with an exemplary embodiment.

FIG. 14 is a cross sectional view of a portion of the header connector in accordance with an exemplary embodiment.

FIG. 15 is a perspective view of the header connector in accordance with an exemplary embodiment.

FIG. 16 is a cross sectional view of a portion of the header connector in accordance with an exemplary embodiment.

FIG. 17 is a perspective view of the header connector in accordance with an exemplary embodiment.

FIG. 18 is a cross sectional view of a portion of the header connector in accordance with an exemplary embodiment.

FIG. 19 is a perspective view of the plug connector in accordance with an exemplary embodiment.

FIG. 20 is a cross sectional view of a portion of the plug connector in accordance with an exemplary embodiment.

FIG. 21 is a perspective view of the plug connector in accordance with an exemplary embodiment.

FIG. 22 is a cross sectional view of a portion of the plug connector in accordance with an exemplary embodiment.

FIG. 23 is a top view of a portion of the plug connector in accordance with an exemplary embodiment.

### DETAILED DESCRIPTION OF THE INVENTION

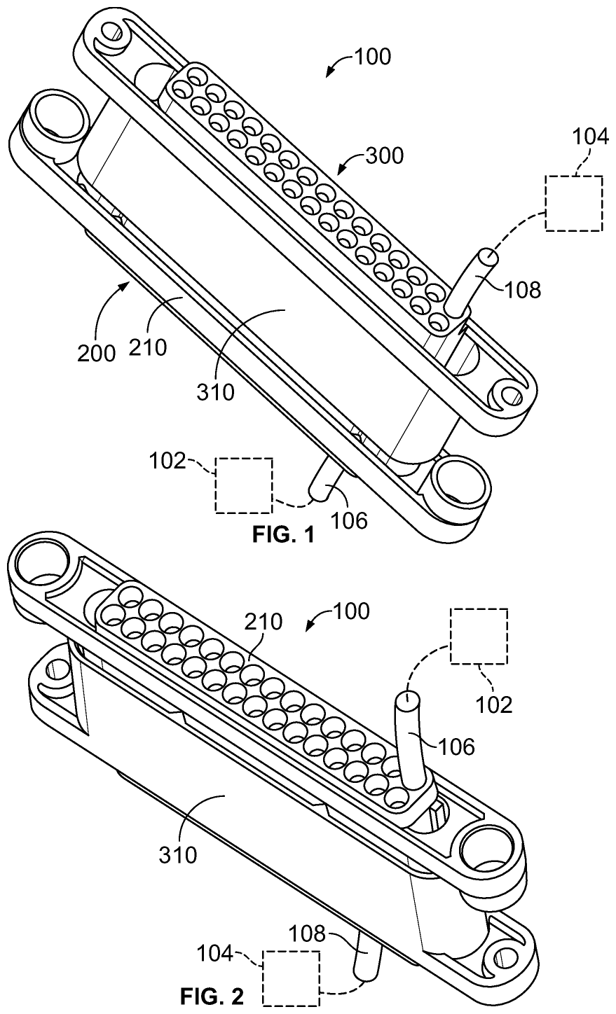

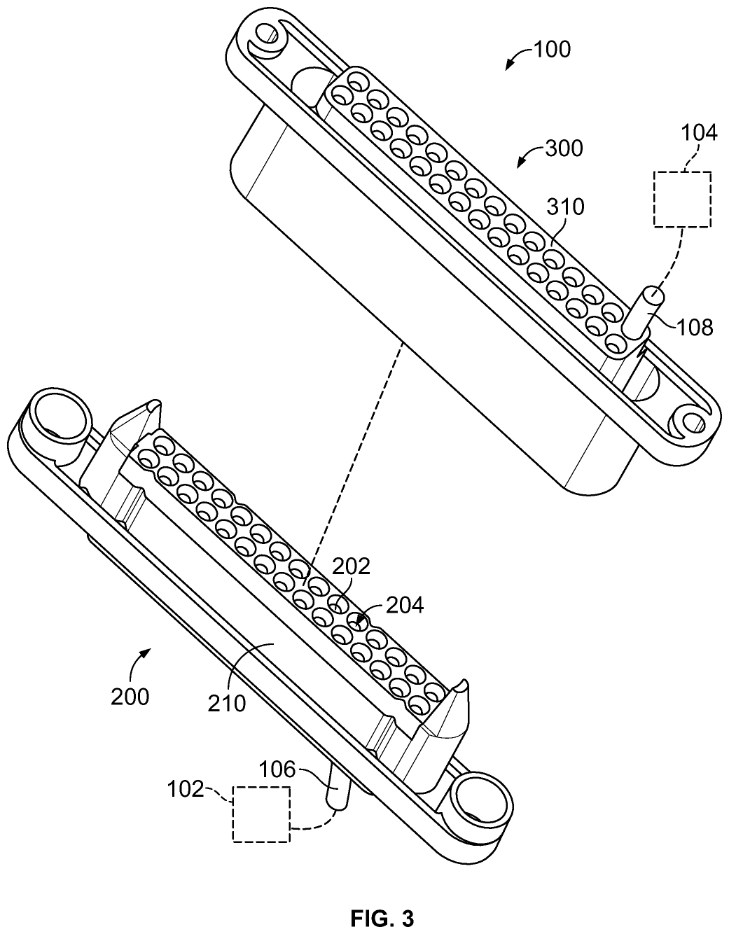

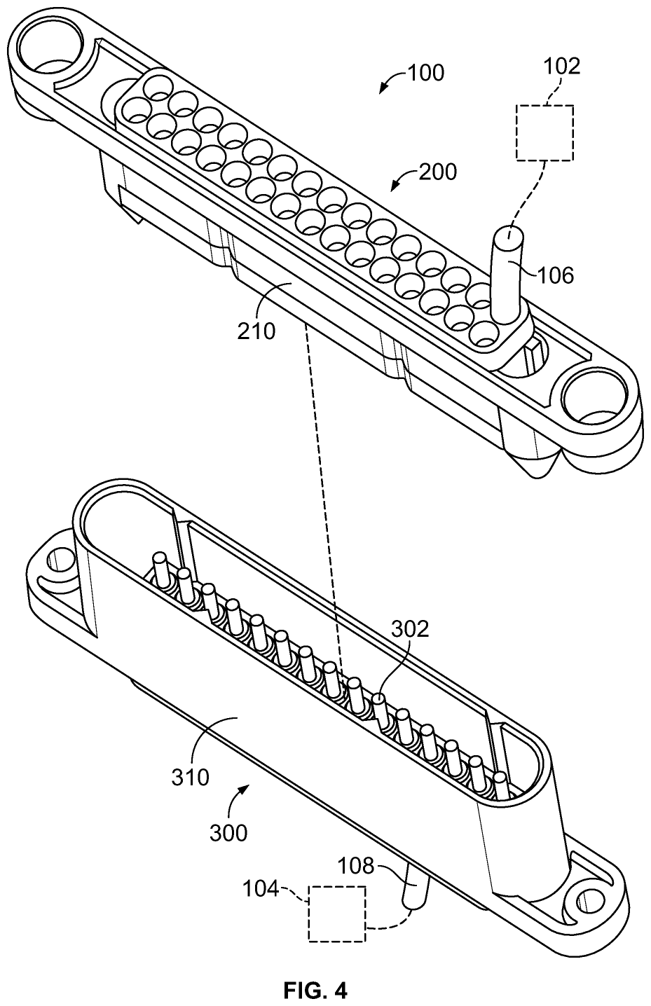

FIG. 1 is a front perspective view of an electrical connector system 100 in accordance with an exemplary embodiment. FIG. 2 is a rear perspective view of the electrical connector system 100 in accordance with an exemplary embodiment. FIG. 3 is an exploded, front perspective view of the electrical connector system 100 in accordance with an exemplary embodiment. FIG. 4 is an exploded, rear perspective view of the electrical connector system 100 in accordance with an exemplary embodiment.

The electrical connector system 100 includes a plug connector 200 and a header connector 300 configured to be mated together to electrically connect a first component 102 and a second component 104. In various embodiments, the plug connector 200 is electrically connected to the first component 102 by wires 106 (only one illustrated in the Figures). However, the plug connector 200 may be electrically connected to the first component 102 through a circuit board (not shown). In various embodiments, the header connector 300 is electrically connected to the second component 104 by wires 108 (only one illustrated in the Figures). However, the header connector 300 may be electrically connected to the second component 104 through a circuit board (not shown). In the illustrated embodiment, the plug connector 200 and the header connector 300 are cable connectors terminated to ends of the cables or wires 106, 108. In other various embodiments, the plug connector 200 and/or the header connector 300 may be a board connector mounted to a circuit board.

In an exemplary embodiment, the header connector 300 may be physically mounted to the second component 104. For example, the header connector 300 may be mounted to the second component 104 using fasteners, latches, clips, welding, or other attachment means. In an exemplary embodiment, the plug connector 200 may be physically mounted to the first component 102. For example, the plug connector 200 may be mounted to the first component 102 using fasteners, latches, clips, welding, or other attachment means. The plug connector 200 may be mated with the header connector 300 when the first component 102 is mated with the second component 104. In an example, the electrical connector system 100 is part of an appliance, such as a coffeemaker. The plug connector 200 may be integrated with a removable component of the appliance, which is mated to the header connector 300 when the removable component is coupled to the appliance. For example, the plug connector 200 may be integrated into a drawer or cup or water container that is removable from the appliance and configured to be plugged back into the appliance during operation of the appliance. The plug connector 200 is mated with the header connector 300 when such removable component is plugged back into the appliance. The electrical connector system 100 may be used in other types of appliances in alternative embodiments. The electrical connector system 100 may be used in other applications other than appliances in other alternative embodiments, such as an automotive application, an industrial application, a computer application, a network application, a vehicle, a machine, a device, or other type of application where 2 electrical connectors are mated to electrically connect corresponding components.

The plug connector 200 includes a plurality of contacts 202 (FIG. 3), which are configured to be terminated to the wires 106 (or the circuit board in a board mounted application). The plug connector 200 includes a plug housing 210 that holds the contacts 202. In an exemplary embodiment, the contacts 202 are socket contacts having sockets 204 at mating ends of the contacts 202. In an exemplary embodiment, the plug connector 200 includes a contact organizer 260 configured to position the contacts 202 within the plug housing 210. The contact organizer 260 is used to guide mating of the contacts of the header connector 300 with the contacts 202 of the plug connector 200. The contact organizer 260 prevents stubbing of the contacts 202 during mating to prevent damage to the contacts 202.

The header connector 300 includes a plurality of pin contacts 302 (FIG. 4), which are configured to be terminated to the wires 108 (or the circuit board in a board mounted application). The header connector 300 includes a header housing 310 that holds the pin contacts 302. In an exemplary embodiment, the pin contacts 302 include pins at mating ends of the pin contacts 302, which are configured to be received in the sockets 204 of the contacts 202. The pins are configured to be guided into the sockets 204 by the contact organizer 260.

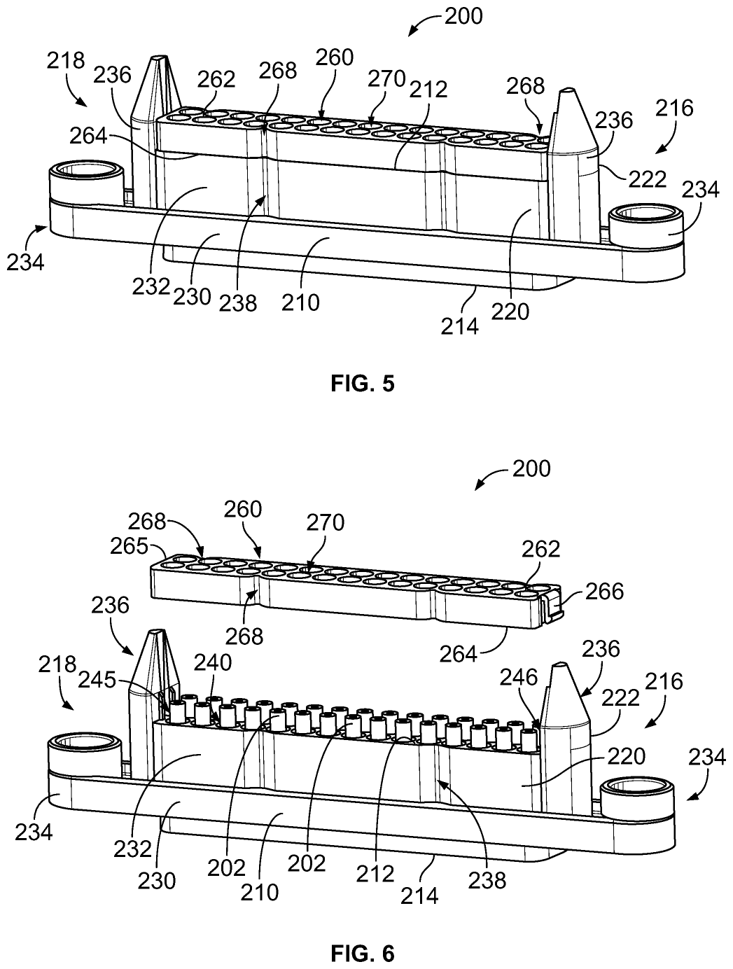

FIG. 5 is a perspective view of the plug connector 200 in accordance with an exemplary embodiment. FIG. 6 is an exploded, perspective view of the plug connector 200 in accordance with an exemplary embodiment. FIG. 6 illustrates the contacts 202 arranged in the plug housing 210. The contact organizer 260 is shown poised for mating with the plug housing 210.

The plug housing 210 is manufactured from a dielectric material, such as a plastic material. The plug housing 210 may be an injection molded part. The plug housing 210 extends between a front 212 and a rear 214. The plug housing 210 has a first end 216 and a second end 218 opposite the first end 216. The plug housing 210 includes a first side 220 and a second side 222 opposite the first side 220. The sides 220, 222 extend between the ends 216, 218. In an exemplary embodiment, the sides 220, 222 are planar and parallel to each other. The ends 216, 218 may be planar. However, in alternative embodiments, the ends 216, 218 are curved between the sides 220, 222. In an exemplary embodiment, the plug housing 210 is elongated end to end. For example, the sides 220, 222 are longer than the ends 216, 218. In various embodiments, the plug housing 210 is generally oval shaped, such as racetrack shaped. However, the plug housing 210 may have other shapes in alternative embodiments, such as rectangular shaped.

In an exemplary embodiment, the plug housing 210 includes a base 230 and a contact block 232 extending from the base 230 toward the front 212. The base 230 may be located at the rear 214. In various embodiments, the base 230 may be mounted to a structure or component. For example, the plug housing 210 may include mounting elements 234 extending from the base 230. In the illustrated embodiment, the plug housing 210 includes mounting elements 234 located at the ends 216, 218. The mounting elements 234 may be located at other positions in alternative embodiments. The mounting elements 234 may be used to secure the plug housing 210 to another structure or component. Optionally, the mounting elements 234 may be used to secure the plug connector 200 to the header connector 300. The mounting elements 234 may include openings therethrough that receive fasteners or other securing elements.

In an exemplary embodiment, the plug housing 210 includes one or more guide features 236 to guide mating with the header connector 300. In the illustrated embodiment, the guide features 236 are guide posts extending forward from the base 230. The guide posts may be cylindrical. Optionally, the guide posts may be truncated such as being semicylindrical. In the illustrated embodiment, the guide features 236 are located at the ends 216, 218. Other locations are possible in alternative embodiments. Optionally, the guide features 236 may be the forwardmost portions of the plug connector 200 such that the guide features 236 are the first elements of the plug connector 200 to mate with the header connector 300. In various embodiments, the guide features 236 are cone-shaped at distal ends to aide in aligning the plug connector 200 with the header connector 300. For example, the guide features 236 include lead-in surfaces at the distal ends thereof. The guide features 236 may have smaller diameters at the tip and larger diameters along the posts. The guide features 236 may be used to guide mating in various directions, such as side to side and/or end to end.

In an exemplary embodiment, the plug housing 210 includes one or more alignment features 238 to align the plug housing 210 with the header connector 300. In the illustrated embodiment, the alignment features 238 include grooves formed along the sides 220, 222 that receive complimentary protrusions of the header connector 300 to position the plug connector 200 relative to the header connector 300 when mated thereto. The grooves may be V-shaped grooves. However, the grooves may have other shapes in alternative embodiments. The alignment features 238 may be used to align the plug connector 200 relative to the header connector 300 in various directions, such as side to side and/or end to end. In an exemplary embodiment, the alignment features 238 are positioned along the plug housing 210 for keyed mating with the header connector 300. For example, the alignment features 238 may prevent mating of the plug connector 200 with the header connector 300 in an improper orientation. In various embodiments, the positioning and/or spacing of the alignment features 238 along the sides 220, 222 provide keyed mating with the header connector 300. Optionally, the number of alignment features 238 along the first side 220 may be different than the number of alignment features 238 along the second side 222.

In an exemplary embodiment, the contact block 232 of the plug housing 210 includes contact channels 240 passing therethrough. The contact channels 240 receive corresponding contacts 202 of the plug connector 200. The contact channels 240 are open at the front 212 and/or the rear 214 to receive the contacts 202. In various embodiments, the contact channels 240 are cylindrical to receive the contacts 202. The contact channels 240 may have other shapes in alternative embodiments, such as being rectangular. In an exemplary embodiment, the contact channels 240 are arranged in multiple rows and multiple columns. For example, in the illustrated embodiment, the plug housing 210 includes two rows of the contact channels 240, each including fifteen columns of the contact channels 240. The rows are oriented parallel to the sides 220, 222. Optionally, the columns may be oriented perpendicular to the sides 220, 222. However, in alternative embodiments, the rows of the contact channels 240 may be offset such that the contact channels 240 in the adjacent rows are staggered for tighter positioning of the contact channels 240 and the contacts 202 within the plug housing 210. Optionally, the plug housing 210 may include greater or fewer rows and/or columns of the contact channels 240. In an exemplary embodiment, the contacts 202 are rear loaded into the contact channels 240 through the rear 214, such as through the base 230. In alternative embodiments, the contacts 202 may be front loaded into the contact channels 240 through the front 212. In an exemplary embodiment, the mating ends of the contacts 202 are located forward of the front 212 of the plug housing 210. The mating ends of the contacts 202 are configured to be received in the contact organizer 260 with the contact organizer 260 is coupled to the front 212 of the plug housing 210.

The contact organizer 260 is configured to be coupled to the plug housing 210. In an exemplary embodiment, the contact organizer 260 is separate and discrete from the plug housing 210 and coupled thereto to cover the mating ends of the contacts 202. The contact organizer 260 is manufactured from a dielectric material, such as a plastic material. The contact organizer 260 may be an injection molded part.

The contact organizer 260 extends between an outer side 262 at the front of the contact organizer 260 and an inner side 264 at the rear of the contact organizer 260. The inner side 264 faces the plug housing 210. The inner side 264 may be coupled to the front 212 of the plug housing 210. In the illustrated embodiment, the contact organizer 260 is generally rectangular having opposite sides and opposite ends. Other shapes are possible in alternative embodiments. In an exemplary embodiment, the contact organizer 260 includes alignment features 268 along the opposite sides of the contact organizer 260. The alignment features 268 are configured to be aligned with the alignment feature 238 of the plug housing 210. The alignment feature 268 may be shaped and positioned complementary to the alignment features 238 to receive the corresponding alignment features of the header connector 300 to ensure proper mating of the plug connector 200 with the header connector 300.

In an exemplary embodiment, the contact organizer 260 includes latches 265, 266 at opposite ends of the contact organizer 260. The latches 265, 266 are configured to be latchably coupled to the plug housing 210 to secure the contact organizer 260 to the plug housing 210. For example, the latches 265, 266 may be received in the latch pockets 245, 246 at the ends 216, 218 of the contact block 232. The latch pockets 245, 246 may be formed in the guide features 236. In various embodiments, the latches 265, 266 and the latch pockets 245, 246 are keyed for keyed mating of the contact organizer 260 to the plug housing 210. For example, the latches 265, 266 may have different widths that are configured to be received in the corresponding latch pockets 245, 246 in a single orientation. For example, the wider of the two latches 265, 266 may be unable to be received in the incorrect latch pocket. Other types of pull arising features may be used in eternity embodiments. Additionally, other types of securing features may be used to secure the contact organizer 260 to the plug housing 210, such as fasteners, clips, or other securing means.

The contact organizer 260 includes bores 270 passing therethrough between the outer side 262 and the inner side 264. The bores 270 are configured to receive the corresponding contacts 202. The bores 270 are arranged in an array complementary to the array of contact channels 240. The bores 270 are configured to be aligned with the contact channels 240 to receive the contacts 202. The bores 270 are open at the inner side 264 and the outer side 262. The bores 270 receive the mating ends of the contacts 202 at the inner side 264. The bores 270, at the outer side 262, are configured to receive the contacts 302 of the header connector 300 to guide mating of the pin contacts 302 of the header connector 300 with the contacts 202. In an exemplary embodiment, the bores 270 are sized and shaped to align the pin contacts 302 and the contacts 202 during mating to prevent stubbing and/or damage to the contacts during mating.

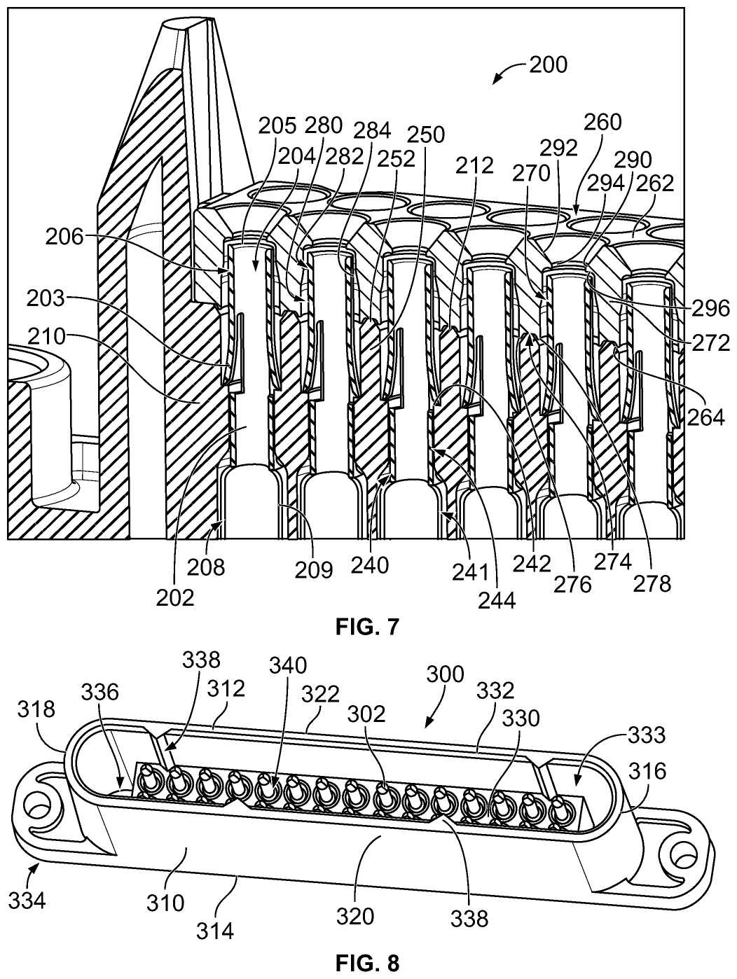

FIG. 7 is a cross-sectional view of a portion of the plug connector 200 in accordance with an exemplary embodiment. FIG. 7 illustrates the contact organizer 260 coupled to the plug housing 210. FIG. 7 illustrates a plurality of the contacts 202 in the contact channels 240 of the plug housing 210 and the bores 270 of the contact organizer 260.

Each contact 202 extends between a mating end 206 and a terminating end 208. In the illustrated embodiment, the socket 204 is provided at the mating end 206. The socket 204 is configured to receive the corresponding pin contact 302 of the header connector 300. In an exemplary embodiment, the socket 204 is cylindrical. The socket 204 extends to a distal end 205. The terminating end 208, opposite the mating end 206, is configured to be terminated to the corresponding wire 106. In an exemplary embodiment, the terminating end 208 includes a crimp barrel 209 configured to be crimped to the end of the wire 106. In alternative embodiments, the terminating end 208 may include an insulation displacement contact. In other alternative embodiments, the terminating end 208 may include a weld pad or solder pad configured be welded or soldered to the end of the wire 106. In other alternative embodiments, the terminating end 208 may be configured to be terminated to a circuit board. For example, the weld pad or solder pads may be welded or soldered to a circuit of the circuit board. In other alternative embodiments, the terminating end 208 may include a compliant pin configured to be press-fit into a plated via of the circuit board.

In an exemplary embodiment, the contact 202 includes securing features 203 used to secure the contact 202 in the plug housing 210. In the illustrated embodiment, the securing features 203 include latches or barbs extending from one or more sides of the contacts 202. The securing feature 203 are configured to engage a shoulder 242 in the contact channel 240 to hold the contact 202 in the contact channel 240. The securing feature 203 engages the shoulder 242 to prevent pullout or backout of the contact 202 from the contact channel 240. In the illustrated embodiment, the shoulder 242 is located forward of a holding portion 244 of the contact channel 240. The holding portion 244 has a smaller diameter than other portions of the contact channel 240. The holding portion 244 is used to orient the contacts 202 in the contact channel 240. For example, the holding portion 244 may be used to center of the contacts 202 in the contact channel 240. Optionally, the contacts 202 may have a limited amount of floating movement within the contact channel 240, such as to align the contacts 202 to the pin contacts 302 during mating. For example, the contacts 202 may be allowed to tilt or pivot in one or more directions (for example, side to side and/or end to end) a small amount to align with the pin contact 302 during mating. The securing features 202 may be deflectable to allow the limited amount of floating movement of the contact 202 in the contact channel 240. The securing features 203 are flexible and tend to center the contact 202 in the contact channel 240.

In an exemplary embodiment, the contact channel 240 includes an enlarged portion 241 rearward of the holding portion 244. The enlarged portion 241 have a larger diameter than the holding portion 244. The enlarged portion 241 may be oversized to receive the end of the wire 106. The terminating end 208 of the contact 202 is located in the enlarged portion 241. The enlarged portion 241 is located at the rear 214 of the plug housing 210. The enlarged portion 241 may define a cable channel or wire channel that receives the end of the wire 106. The contact channel 240 has a first diameter along the holding portion 244, a second diameter along the forward portion forward of the shoulder 242, and a third diameter along the enlarged portion 241. The first diameter may be the smallest diameter along the contact channels 240. The third diameter along the enlarged portion may be the largest diameter of the contact channel 240.

In an exemplary embodiment, the plug housing 210 includes housing walls 250 between the contact channels 240. The housing walls 250 separate the contacts 202 from each other, such as to prevent short circuiting between the contacts 202. The housing walls 250 have peripheral edges 252 surrounding peripheries of the contact channels 240. The peripheral edges 252 are located at the front 212 of the plug housing 210. Optionally, the housing walls 250 are chamfered at the peripheral edges 252.

The contact organizer 260 is coupled to the front 212 of the plug housing 210. For example, the inner side 264 of the contact organizer 260 is coupled to the front 212 of the plug housing 210. The bores 270 are aligned with the contact channels 240. In an exemplary embodiment, the contact organizer 260 includes separating walls 272 between the bores 270. The separating walls 272 separate the bores 270 and the contacts 202 located in the bores 270 from each other, such as to prevent short circuiting of the contacts 202. The separating walls 272 are coupled to the corresponding housing walls 250 of the plug housing 210. In an exemplary embodiment, the separating walls 272 include pockets 274 along the inner side 264 that receive the peripheral edges 252 of the housing walls 250. In an exemplary embodiment, the pockets 274 system in positioning the contact organizer 260 relative to the plug housing 210. For example, the pockets 274 may be used to align the contact organizer 260 side to side and/or end to end relative to the plug housing 210. For example, flanges 276, 278 extend along both sides of the pockets 274 to interface with the peripheral edges 252 of the housing walls 250. The flanges 276, 270 may be angled or chamfered to receive the chamfered peripheral edges 252, which help center the contact organizer 260 relative to the plug housing 210. The flanges 276, 278 overlap with the peripheral edges 252 to increase the creep distance between the contacts 202, such as by eliminating straight-line paths between the contacts 202 at the interface between the contact organizer 260 and the plug housing 210.

In an exemplary embodiment, the bores 270 have variable diameters along the lengths of the bores 270. For example, at the bottom of the contact organizer 260, each bore 270 includes a large diameter section 280. The bore 270 includes a reduced diameter section 282 above (for example, forward of) the large diameter section 280. In an exemplary embodiment, the separating walls 272 of the contact organizer 270 includes a neck region 284 defining the reduced diameter section 282. The separating walls 272 are necked inward to reduce the diameter of the bore 270 along the reduced diameter section 282. The neck region 284 is used to center position the socket 204 of the contact 202 in the bore 270. For example, when the contact organizer 260 is coupled to the front 212 of the plug housing 210, the contacts 202 is initially loaded into the large diameter section 280. The large diameter section 280 is a larger diameter than the diameter of the socket 204 to gather the socket 204 in the bore 270. As the contact organizer 260 is lowered onto the plug housing 210, the neck region 284 centers the contacts 202 in the bore 270. Optionally, the diameter of the bore 270 along the reduced diameter section 282 may be approximately equal to, but slightly larger than, the socket 204 to allow easy loading of the socket 204 into the bore 270 while ensuring that the socket 204 is centered within the bore 270. In an exemplary embodiment, the diameter of the bore 270 along the reduced diameter section 282 is smaller than a diameter of the contact channel 240 of the plug housing 210. As such, the contact organizer 260, rather than the plug housing 210 controls the positioning (for example, end to end and/or side-to-side) of the contacts 202.

In an exemplary embodiment, the contact organizer 260 includes caps 290 at the front of the contact organizer 260. The caps 290 extend into the bores 270. The caps 290 overhang the distal ends 205 of the contacts 202. The caps 290 F lead-in surfaces 292 used to guide the pin contacts 302 of the header connector 300 into the bores 270. The lead in surfaces 292 are angled or tapered such that the bore 270 is a larger diameter at the outer surface 262 and a narrower diameter at an inner edge 294 of the cap 290. The cap 290 includes a flange facing inward. The flange 296 extends between the inner edge 294 and the neck region 284. The flange 296 faces the distal end 205 of the contact 202. The flange 296 covers the contacts 202 to prevent forward movement of the contacts 202 in the bore 270. The contact 202 is captured between the flange 296 and the shoulder 242. In an exemplary embodiment, the contact organizer 260 has a smaller diameter at the inner edge 294 of the cap 290 than the diameter of the socket 204. For example, the flange 296 overhangs the distal end 205 of the contacts 202 to prevent stubbing of the pin contacts 302 on the end of the contact 202 during mating. The diameter at the inner edge 294 is larger than the diameter of the pin contacts 302 to allow the pin contacts 302 to pass through the cap 290 into the socket 204. The cap 290 guides the pin contacts 302 into the socket 204.

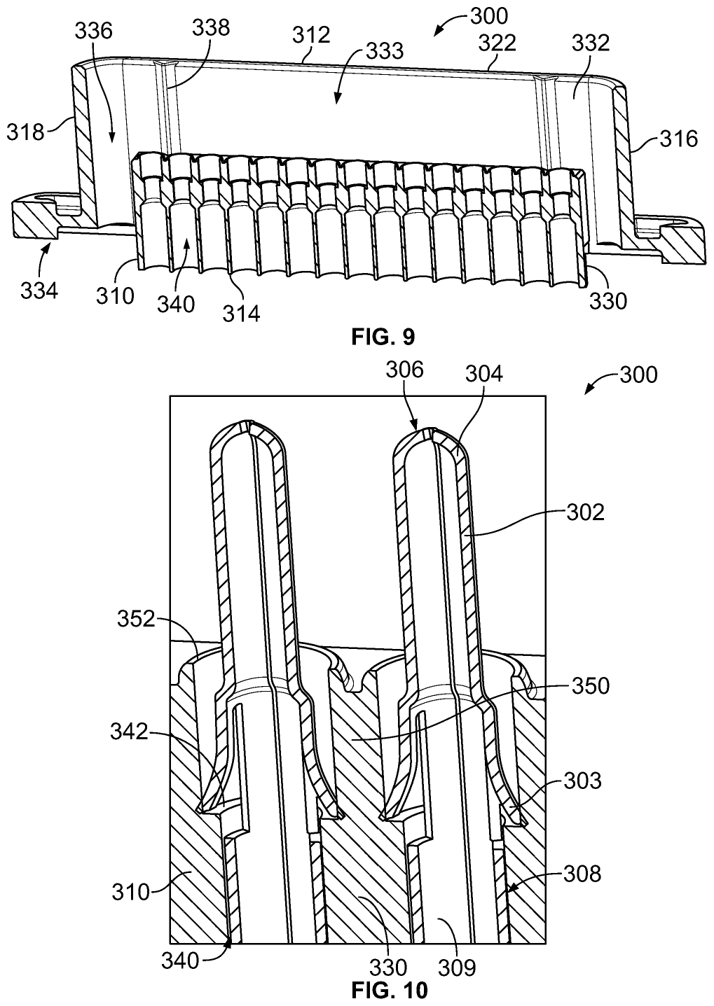

FIG. 8 is a perspective view of the header connector 300 in accordance with an exemplary embodiment. FIG. 9 is a cross sectional view of a portion of the header connector 300 in accordance with an exemplary embodiment. FIG. 9 illustrates the header housing 310 with the pin contacts 302 removed to illustrate the header housing 310.

The header housing 310 is manufactured from a dielectric material, such as a plastic material. The header housing 310 may be an injection molded part. The header housing 310 extends between a front 312 and a rear 314. The header housing 310 has a first end 316 and a second end 318 opposite the first end 316. The header housing 310 includes a first side 320 and a second side 322 opposite the first side 320. The sides 320, 322 extend between the ends 316, 318. In an exemplary embodiment, the sides 320, 322 are planar and parallel to each other. The ends 316, 318 may be planar. However, in alternative embodiments, the ends 316, 318 are curved between the sides 320, 322. In an exemplary embodiment, the header housing 310 is elongated end to end. For example, the sides 320, 322 are longer than the ends 316, 318. In various embodiments, the header housing 310 is generally oval shaped, such as racetrack shaped. However, the header housing 310 may have other shapes in alternative embodiments, such as rectangular shaped.

In an exemplary embodiment, the header housing 310 includes a base 330 and a shroud 332 extending from the base 330 toward the front 312. The shroud 332 forms a cavity 333 configured to receive the plug connector 200. The cavity 333 is sized and shaped to receive the plug housing 210. The base 330 may be located at the rear 314. In various embodiments, the base 330 may be mounted to a structure or component. For example, the header housing 310 may include mounting elements 334 extending from the base 330. In the illustrated embodiment, the header housing 310 includes mounting elements 334 located at the ends 316, 318. The mounting elements 334 may be located at other positions in alternative embodiments. The mounting elements 334 may be used to secure the header housing 310 to another structure or component. Optionally, the mounting elements 334 may be used to secure the header connector 300 to the plug connector 200. The mounting elements 334 may include openings therethrough that receive fasteners or other securing elements.

In an exemplary embodiment, the header housing 310 includes one or more guide features 336 to guide mating with the header connector 300. The guide features 336 may be used to guide mating in various directions, such as side to side and/or end to end. In the illustrated embodiment, the guide features 336 are openings. The openings 336 may be provided in the shroud 332 and/or the base 330. The openings 336 may be extending forward from the base 330. The openings 336 may be cylindrical. However the openings 336 may have other shapes. For example, the openings 336 may be semicylindrical having at least one flat side. In the illustrated embodiment, the guide features 336 are located at the ends 316, 318. Other locations are possible in alternative embodiments.

In an exemplary embodiment, the header housing 310 includes one or more alignment features 338 to align the header housing 310 with the header connector 300. In the illustrated embodiment, the alignment features 338 include protrusions along the sides 320, 322 configured to be mated with the alignment features 238 of the plug housing 210 to position the header connector 300 relative to the plug connector 200 when mated thereto. The protrusions 338 may extend from the shroud 332 into the cavity 333. The protrusions 338 may be V-shaped. However, the protrusions 338 may have other shapes in alternative embodiments. The alignment features 338 may be used to align the header connector 300 relative to the plug connector 200 in various directions, such as side to side and/or end to end. In an exemplary embodiment, the alignment features 338 are positioned along the header housing 310 for keyed mating with the header connector 300. For example, the alignment features 338 may prevent mating of the header connector 300 with the plug connector 200 in an improper orientation. In various embodiments, the positioning and/or spacing of the alignment features 338 along the sides 320, 322 provide keyed mating with the plug connector 200. Optionally, the number of alignment features 338 along the first side 320 may be different than the number of alignment features 338 along the second side 322.

In an exemplary embodiment, the base 330 of the header housing 310 includes contact channels 340 passing therethrough. The contact channels 340 receive corresponding contacts 302 of the header connector 300. The contact channels 340 are open at the front 312 and/or the rear 314 to receive the contacts 302. In various embodiments, the contact channels 340 are cylindrical to receive the contacts 302. The contact channels 340 may have other shapes in alternative embodiments, such as being rectangular. In an exemplary embodiment, the contact channels 340 are arranged in multiple rows and multiple columns. For example, in the illustrated embodiment, the header housing 310 includes two rows of the contact channels 340, each including fifteen columns of the contact channels 340. The rows are oriented parallel to the sides 320, 322. Optionally, the header housing 310 may include greater or fewer rows and/or columns of the contact channels 340. In an exemplary embodiment, the contacts 302 are rear loaded into the contact channels 340 through the rear 314. In an exemplary embodiment, the mating ends of the contacts 302 are located forward of the base 330. The mating ends of the contacts 302 are configured to be plugged into the sockets 204 of the contacts 202 of the plug connector 200.

FIG. 10 is a cross-sectional view of a portion of the header connector 300 in accordance with an exemplary embodiment. FIG. 10 illustrates a plurality of the contacts 302 in the contact channels 340 of the header housing 310.

Each pin contact 302 extends between a mating end 306 and a terminating end 308. In the illustrated embodiment, a pin 304 is provided at the mating end 306. The pin 304 is configured to be received in the socket 204 of the contact 202 of the plug connector 200. In an exemplary embodiment, the pin 304 is generally cylindrical and curved at the top to form a plug end at the tip of the pin 304. The terminating end 308, opposite the mating end 306, is configured to be terminated to the corresponding wire 108. In an exemplary embodiment, the terminating end 308 includes a crimp barrel 309 configured to be crimped to the end of the wire 108. In alternative embodiments, the terminating end 308 may include an insulation displacement contact. In other alternative embodiments, the terminating end 308 may include a weld pad or solder pad configured be welded or soldered to the end of the wire 108. In other alternative embodiments, the terminating end 308 may be configured to be terminated to a circuit board. For example, the weld pad or solder pads may be welded or soldered to a circuit of the circuit board. In other alternative embodiments, the terminating end 308 may include a compliant pin configured to be press-fit into a plated via of the circuit board.

In an exemplary embodiment, the pin contact 302 includes securing features 303 used to secure the pin contact 302 in the header housing 310. In the illustrated embodiment, the securing features 303 include latches or barbs extending from one or more sides of the contacts 302. The securing feature 303 are configured to engage a shoulder 342 in the contact channel 340 to hold the pin contact 302 in the contact channel 340. The securing feature 303 engages the shoulder 342 to prevent pullout or backout of the pin contact 302 from the contact channel 340. The securing features 303 may be used to orient the pin contact 302 in the contact channel 340, such as to center the pin contact 302 in the contact channel 340. Optionally, the pin contact 302 may have a limited amount of floating movement within the contact channel 340, such as to align the contact 302 to the contact 202 during mating. For example, the pin contact 302 may be allowed to tilt or pivot in one or more directions (for example, side to side and/or end to end) a small amount to align with the contact 202 during mating. The securing features 302 may be deflectable to allow the limited amount of floating movement of the pin contact 302 in the contact channel 340. The securing features 303 are flexible and tend to center the pin contact 302 in the contact channel 340.

In an exemplary embodiment, the header housing 310 includes housing walls 350 between the contact channels 340. The housing walls 350 separate the contacts 302 from each other, such as to prevent short circuiting between the contacts 302. The housing walls 350 have peripheral edges 352 surrounding peripheries of the contact channels 340. The peripheral edges 352 are located at the front 312 of the base 330. Optionally, the peripheral edges 352 are chamfered. The peripheral edges 352 may be plugged into the contact organizer 260, such as into the respective bores 270 in the contact organizer 260.

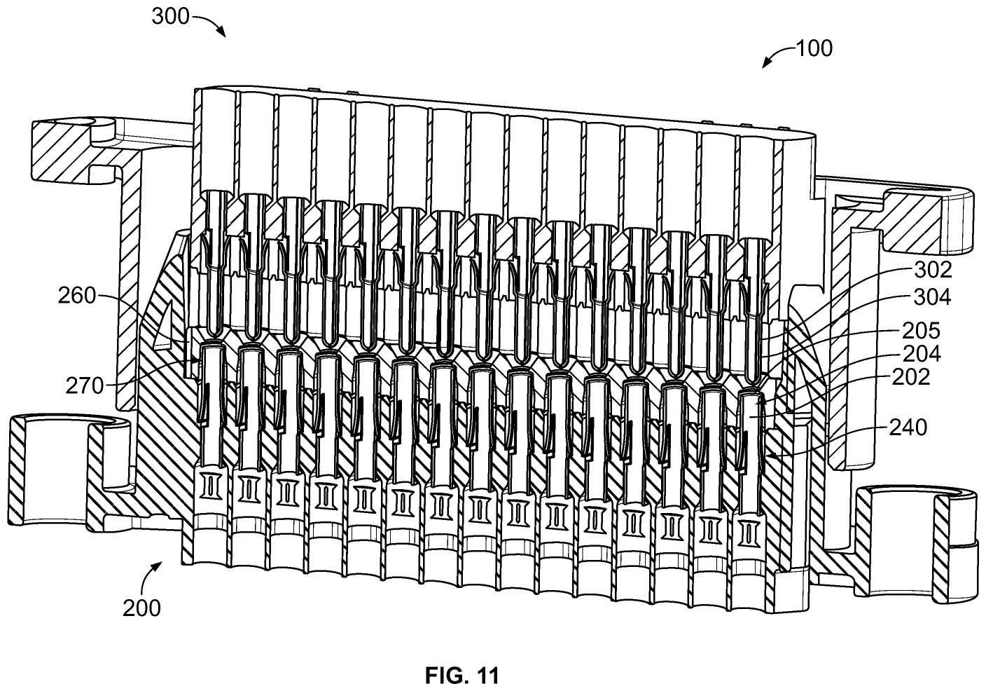

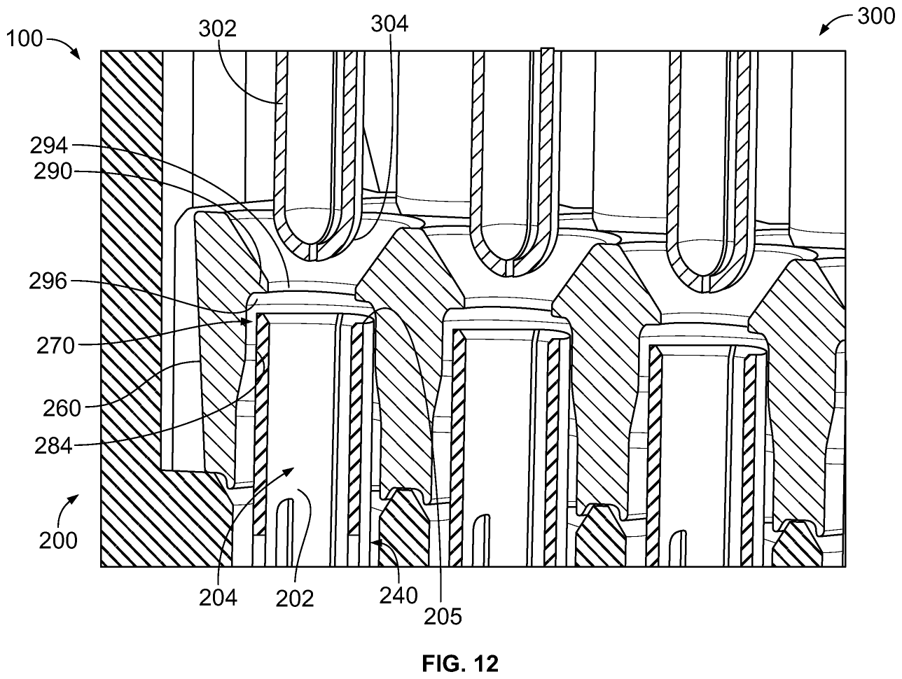

FIG. 11 is a cross sectional view of the electrical connector system 100 in accordance with an exemplary embodiment showing the plug connector 200 partially mated with the header connector 300. FIG. 12 is a cross sectional view of a portion of the electrical connector system 100 in accordance with an exemplary embodiment showing the plug connector 200 partially mated with the header connector 300. FIGS. 11 and 12 illustrate the pin contacts 302 of the header connector 300 aligned with the contacts 202 of the plug connector 200.

In an exemplary embodiment, the contact organizer 260 positions the contacts 202 for mating with the pin contacts 302. For example, the contact organizer 260 centers each contacts 202 in the corresponding contact channel 240 and the corresponding bore 270. The neck region 284 centers the contact 202 in the bore 270. The neck region 284 centers the contact 202 under the cap 290. The flange 296 of the cap 290 overhangs the distal end 205 of the socket 204 to ensure that the pin contact 302 is plugged directly into the socket 204 when the pin contact 302 passes through the inner edge 294 of the cap 290. In an exemplary embodiment, the contact organizer 260 positions the pin contacts 302 for mating with the contacts 202. For example, the cap 290 guides the pin contact 302 into the socket 204. The cap 290 overhang the contact 202 to prevent stubbing of the pin 304 on the distal end 205 of the socket 204 during mating.

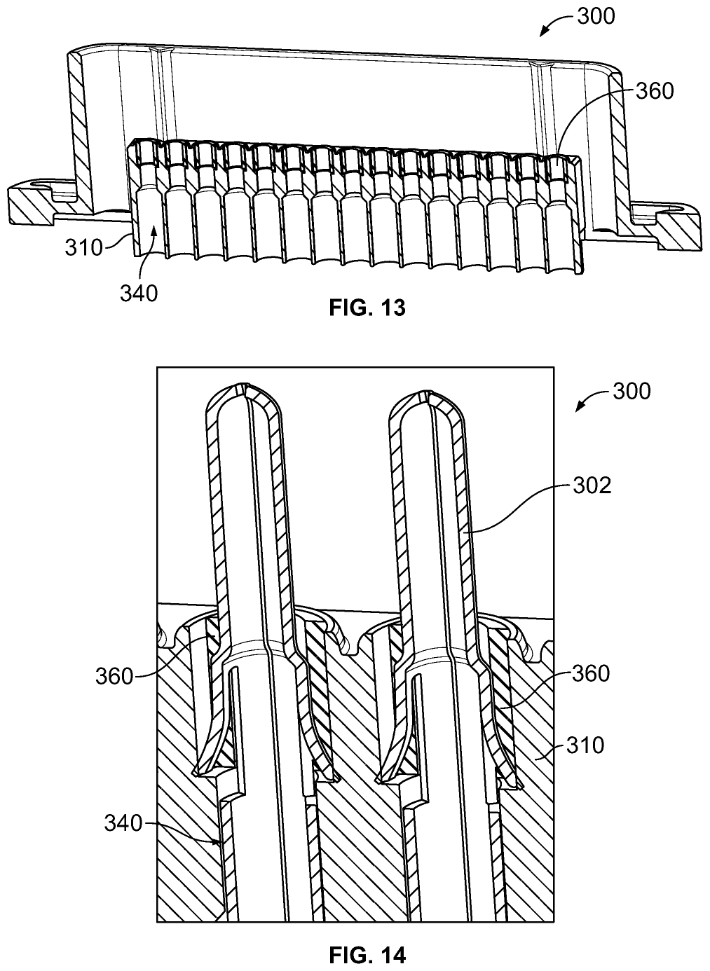

FIG. 13 is a perspective view of the header connector 300 in accordance with an exemplary embodiment. FIG. 14 is a cross sectional view of a portion of the header connector 300 in accordance with an exemplary embodiment. FIG. 13 illustrates the header housing 310 with the pin contacts 302 removed to illustrate the header housing 310.

In an exemplary embodiment, the header connector 300 includes inserts 360 loaded in the header housing 310 to position the pin contacts 302. The inserts 360 are used to center the pin contacts 302 in the contact channels 340, such as to reduce the risk of stubbing during mating with the contacts 202. The inserts 360 reduce the amount of floating movement of the pin contacts 302 in the contact channels 340 to reduce the risk of stubbing during mating with the contacts 202. In the illustrated embodiment, the inserts 360 are separate and discrete from the header housing 310 and coupled to the header housing 310. In the illustrated embodiment, the inserts 360 are separate and discrete from each other, such as being individual inserts 360 received in the corresponding contact channels 340.

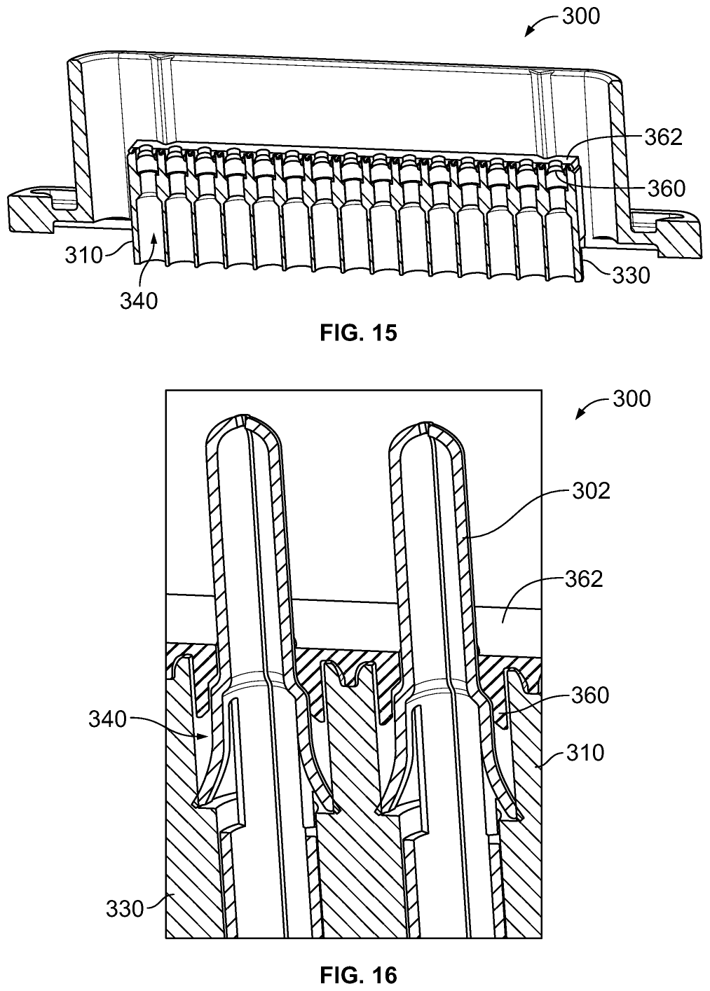

FIG. 15 is a perspective view of the header connector 300 in accordance with an exemplary embodiment. FIG. 16 is a cross sectional view of a portion of the header connector 300 in accordance with an exemplary embodiment. FIG. 15 illustrates the header housing 310 with the pin contacts 302 removed to illustrate the header housing 310.

In an exemplary embodiment, the header connector 300 includes the inserts 360 loaded in the header housing 310 to position the pin contacts 302. In the illustrated embodiment, the inserts 360 are formed on a common carrier 362. For example, each of the inserts 360 is integral with the carrier 362. For example, the inserts 360 may be formed from a molded part. The carrier 362 is coupled to the base 330 with the inserts 360 extending into the contact channels 340 to engage the pin contacts 302. The inserts 360 reduce the amount of floating movement of the pin contacts 302 in the contact channels 340 to reduce the risk of stubbing during mating with the contacts 202.

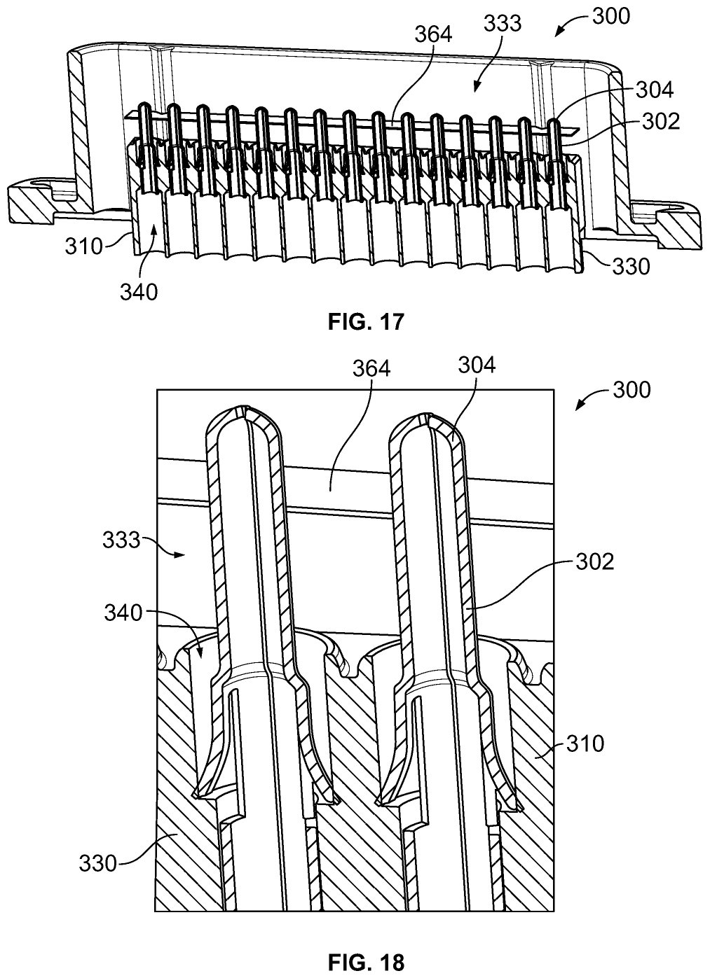

FIG. 17 is a perspective view of the header connector 300 in accordance with an exemplary embodiment. FIG. 18 is a cross sectional view of a portion of the header connector 300 in accordance with an exemplary embodiment.

In an exemplary embodiment, the header connector 300 includes a contact holder 364 used to hold positions of the pin contacts 302 in the header housing 310. In the illustrated embodiment, the contact holder 364 is a film or sheet having openings that receive the pins 304 of the pin contacts 302. The contact holder 364 may be movable in the cavity 333. For example, the contact holder 364 may be moved in the cavity 333 during mating with the plug connector 200. For example, the contact holder 364 may be slid down the pins 304 as the plug connector 200 is mated with he header connector 300. The contact holder 364 may be initially positioned proximate to the distal ends of the pins 304 but slide down the pins 304 during mating to seat against the base 330. The contact holder 364 reduces the amount of floating movement of the pin contacts 302 in the contact channels 340 to reduce the risk of stubbing during mating with the contacts 202.

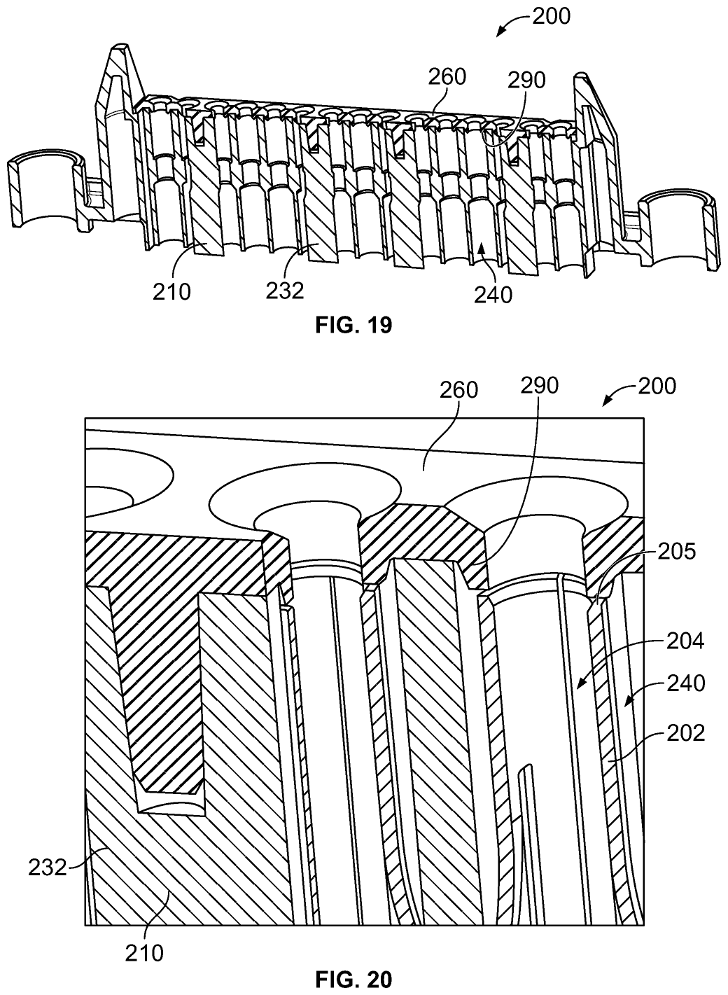

FIG. 19 is a perspective view of the plug connector 200 in accordance with an exemplary embodiment. FIG. 20 is a cross sectional view of a portion of the plug connector 200 in accordance with an exemplary embodiment. FIG. 19 illustrates the plug housing 210 with the contacts 202 removed to illustrate the plug housing 210. The contact organizer 260 is shown coupled to the plug housing 210. The contact organizer 260 is shaped differently than the contact organizer shown in FIG. 7. In the illustrated embodiment, plug housing 210 is taller than in the embodiment shown in FIG. 7. For example, the contact block 232 is positioned forward of the distal ends 205 of the contacts 202. In the illustrated embodiment, the caps 290 extend into the contact channels 240. The caps 290 may engage the distal ends 205 of the contacts 202. The caps 290 overhang the distal ends 205 of the contacts 202 to protect the ends of the contacts 202 and prevent stubbing of the pin contacts 302 when the pin contacts 302 are plugged into sockets 204.

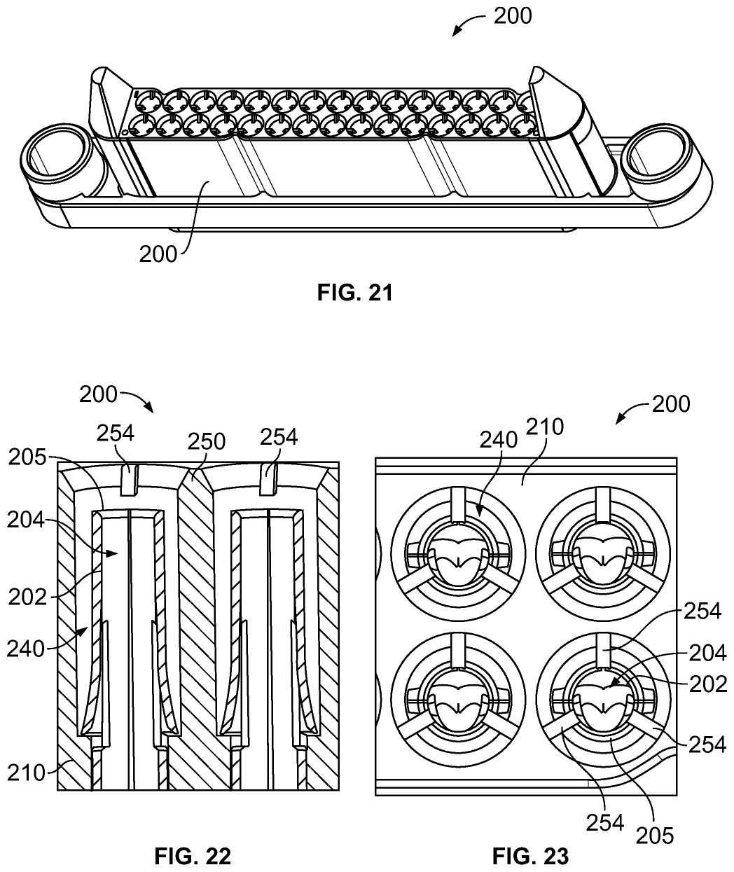

FIG. 21 is a perspective view of the plug connector 200 in accordance with an exemplary embodiment. FIG. 22 is a cross sectional view of a portion of the plug connector 200 in accordance with an exemplary embodiment. FIG. 23 is a top view of a portion of the plug connector 200 in accordance with an exemplary embodiment.

In an exemplary embodiment, the plug connector 200 is provided without the contact organizer (FIG. 7). The plug housing 210 includes features used for centering the contacts 202 and/or the pin contacts 302 to prevent stubbing. For example, the plug housing 210 includes centering fingers 254 that extend into the contact channels 240 from the hosing walls 250. The centering fingers 254 are functionally equivalent to the caps of the contact organizer 260. For example, the centering fingers 254 reduce the diameters of the openings that receive the pin contacts 302 to center the pin contacts 302 and reduce stubbing of the pin contacts 302 on the sockets 204 during mating. The centering fingers 254 overhang the distal ends 205 of the contacts 202 to ensure that the pin contact 302 is received in the socket 204 to prevent stubbing.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

What is claimed is:

1. A plug connector comprising:
a plug housing extending between a front and a rear, the front configured to be mated with a header housing, the plug housing including contact channels extending longitudinally between the front and the rear;
contacts received in the contact channels, the contacts including sockets at mating ends of the contacts configured to receive pin contacts of the header housing, the contacts being arranged in an array having multiple rows and multiple columns; and
a contact organizer coupled to the front of the plug housing, the contact organizer having bores therethrough aligned with the corresponding contact channels, the contact organizer having guide features configured to center the pin contacts in the bores to align the pin contacts with the sockets.

2. The plug connector of claim 1, wherein the contact organizer is separate and discrete from the plug housing and coupled to the plug housing.

3. The plug connector of claim 1, wherein the contacts extend forward of the front of the plug housing into the bores of the contact organizer.

4. The plug connector of claim 1, wherein the bores have variable diameters along central axes of the bores.

5. The plug connector of claim 1, wherein each bore has a reduced diameter section having a diameter larger than a pin diameter of the corresponding pin contact but smaller than a diameter of the corresponding socket.

6. The plug connector of claim 1, wherein the contact organizer includes caps extending into the bores, the caps overhanging distal ends of the sockets.

7. The plug connector of claim 1, wherein each bore includes a neck region that is necked inward, a distal end of the corresponding socket located in the neck region to center the socket in the bore.

8. The plug connector of claim 1, wherein the contacts include retention features engaging the plug housing to position the contacts in the contact channels, the retention features being flexible to allow a limited amount of floating movement of the contacts in the contact channels.

9. The plug connector of claim 1, wherein the plug housing includes housing walls located between the contact channels and having peripheral edges surrounding peripheries of the contact channels, the contact organizer includes separating walls between the bores, the separating walls including grooves at an inner surface of the contact organizer, the grooves receiving the corresponding peripheral edges of the housing walls to locate the contact organizer relative to the plug housing.

10. The plug connector of claim 1, wherein the contact organizer includes latches being latchably coupled to the plug housing.

11. The plug connector of claim 1, wherein the contact organizer and the plug housing include polarizing features to orient the contact organizer relative to the plug housing.

12. The plug connector of claim 1, wherein the plug housing includes guide features extending forward of the front of the plug housing to interface with the header housing and position the header housing relative to the plug housing during mating.

13. The plug connector of claim 1, wherein the contact channels have an inner diameter and wherein the bores have an inner diameter smaller than the inner diameter of the contact channels.

14. A plug connector comprising:
a plug housing extending between a front and a rear, the front configured to be mated with a header housing, the plug housing including contact channels extending longitudinally between the front and the rear;
contacts received in the contact channels, the contacts including sockets at mating ends of the contacts configured to receive pin contacts of the header housing, the sockets having distal edges configured to receive the pin contacts, the contacts being arranged in an array having multiple rows and multiple columns; and
a contact organizer coupled to the front of the plug housing, the contact organizer having bores therethrough aligned with the corresponding contact channels, the contact organizer having caps extending into the bores, the caps overhanging the distal ends of the sockets, the contact organizer having guide features forward of the caps configured to center the pin contacts in the bores to align the pin contacts with the sockets.

15. The plug connector of claim 14, wherein the bores have variable diameters along central axes of the bores.

16. The plug connector of claim 14, wherein each bore has a reduced diameter section having a diameter larger than a pin diameter of the corresponding pin contact but smaller than a diameter of the corresponding socket.

17. The plug connector of claim 14, wherein the contact organizer includes caps extending into the bores, the caps overhanging distal ends of the sockets.

18. The plug connector of claim 14, wherein each bore includes a neck region that is necked inward, a distal ends of the corresponding socket located in the neck region to center the socket in the bore.

19. An electrical connector system comprising:
a header connector having a header housing having channels holding pin contacts in an array having multiple rows and multiple columns, the header housing including a shroud at a mating end of the header connector forming a cavity, the pin contacts extend into the cavity; and
a plug connector mated with the header connector, the plug connector includes a plug housing holding contacts in an array having multiple rows and multiple columns, the plug housing extends between a front and a rear, the front is configured to be plugged into the cavity of the header housing, the plug housing including contact channels that receive the corresponding contacts, the contacts including sockets at mating ends of the contacts configured to receive the corresponding pin contacts, the plug connector including a contact organizer coupled to the front of the plug housing, the contact organizer having bores therethrough aligned with the corresponding contact channels, the contact organizer having guide features configured to center the pin contacts in the bores to align the pin contacts with the sockets during mating.

20. The electrical connector system of claim 19, wherein the plug housing includes guide features extending forward of the front of the plug housing to interface with the header housing and position the header housing relative to the plug housing during mating.
